(19) United States
(12) Patent Application Publication
(10) Pub. No.: US 2025/0159780 A1
(43) Pub. Date: May 15, 2025

(54) MONITORING APPARATUS AND SYSTEM

(71) Applicant: HUAWEI TECHNOLOGIES CO., LTD., Shenzhen (CN)

(72) Inventors: Jianan ZHANG, Shenzhen (CN); Jingjing HUANG, Shenzhen (CN); Junping ZHANG, Shenzhen (CN)

(73) Assignee: HUAWEI TECHNOLOGIES CO., LTD., Shenzhen (CN)

(21) Appl. No.: 19/028,315

(22) Filed: Jan. 17, 2025

Related U.S. Application Data
(63) Continuation of application No. PCT/CN2022/115554, filed on Aug. 29, 2022.

(51) Int. Cl. H05B 47/13; H05B 47/125; H05B 47/16; H05B 47/175

(52) U.S. Cl. CPC H05B 47/13; H05B 47/125; H05B 47/16; H05B 47/196

(57) ABSTRACT

A method includes: a processing apparatus receives collected information from a detector. The collected information includes at least one of the following: reflected-light information of a user, thermal radiation information of the user, or image information of the user. The processing apparatus determines, based on the collected information, a first optical receiver unit that is in the detector and that collects ROI information of the user. The processing apparatus determines, based on a correspondence between optical receiver units and time units, a first time unit corresponding to the first optical receiver unit. The processing apparatus increases an irradiation power of a light source in the first time unit.

### CROSS-REFERENCE TO RELATED APPLICATIONS

This is a continuation of International Patent Application No. PCT/CN2022/115554, filed on Aug. 29, 2022, the disclosure of which is hereby incorporated by reference in its entirety.

### TECHNICAL FIELD

The embodiments relate to the field of communication technologies, and to a monitoring apparatus and system.

### BACKGROUND

With development of intelligent terminal technologies, intelligent wearable devices are widely used in monitoring physiological parameters related to human bodies. Intelligent wearable devices such as smartphones or smart bands may measure various physiological parameters of users, for example, blood pressure, respiration, blood volume, and other circulation conditions of the users. Monitoring users by using optical measurement means is a current research direction.

### SUMMARY

The embodiments provide a monitoring method, apparatus, and system, to monitor a user by optical measuring.

According to a first aspect, a monitoring method is provided. The method may be performed by a processing apparatus. The processing apparatus may be a communication device, or a communication apparatus, for example, a chip, that supports a function required by a communication device to implement the method. For example, the communication apparatus is a terminal device, or a chip disposed in a terminal device and configured to implement a function of a communication device, or another component configured to implement a function of a terminal device. The terminal device may be a mobile phone, a tablet computer, a computer with a wireless transceiver function, a wearable device, a vehicle, an unmanned aerial vehicle, a helicopter, an airplane, a ship, a robot, a robot arm, a smart home device, or the like. An example in which the processing apparatus performs the method is used. The method includes: the processing apparatus receives collected information from a detector. The collected information includes at least one of the following: reflected-light information of a user, thermal radiation information of the user, or image information of the user. The processing apparatus determines, based on the collected information, a first optical receiver unit that is in the detector and that collects region of interest (ROI) information of the user. The processing apparatus determines, based on a correspondence between optical receiver units and time units, a first time unit corresponding to the first optical receiver unit. The processing apparatus increases an irradiation power of a light source in the first time unit.

Through the foregoing implementation, the processing apparatus controls the light source to increase the irradiation power of the light source in the first time unit corresponding to the first optical receiver unit, so that a problem of a poor monitoring effect caused by insufficient light can be resolved. In addition, the processing apparatus does not increase the irradiation power of the light source in other time units than the first time unit, so that a problem of poor user experience caused by excessively strong external light intensity can also be resolved.

In some embodiments, that the processing apparatus increases the irradiation power of the light source in the first time unit includes: the processing apparatus controls the communication apparatus to increase the irradiation power of the light source in the first time unit. For example, the processing apparatus sends notification information to the communication apparatus. The notification information is used to notify the communication apparatus to increase the irradiation power of the light source in the first time unit. Optionally, increasing the irradiation power of the light source in the first time unit includes: irradiating, by the light source, outward at a preset power in the first time unit. Optionally, for other time units than the first time unit, the light source is turned off. Alternatively, in the first time unit, the light source shines outward at a first power. Optionally, for other time units than the first time unit, the light source shines outward at a second power. The first power is greater than the second power, or the like.

Through the foregoing implementation, the processing apparatus can directly control the light source to increase the irradiation power, or control, through the communication apparatus, the light source to increase the irradiation power, to control the light source to increase the irradiation power of the light source in the first time unit corresponding to the first optical receiver unit.

In some embodiments, that the processing apparatus determines, based on the collected information, the first optical receiver unit that is in the detector and that collects the ROI information of the user includes: the processing apparatus determines at least one of the following information of the user based on the collected information: depth information, light intensity information, or temperature information. The depth information includes information about a distance between the user and the detector. The processing apparatus determines, based on at least one of the depth information, the light intensity information, or the temperature information of the user, the first optical receiver unit that is in the detector and that collects the ROI information of the user.

In some embodiments, the method further includes: the processing apparatus determines a communication time unit based on the first time unit. No intersection set exists between the communication time unit and the first time unit. The processing apparatus sends a communication signal to the communication apparatus in the communication time unit.

Through the foregoing implementation, communication between the processing apparatus and an external apparatus can be implemented in non-monitoring time, so that the entire system has a function of communicating with the outside.

In some embodiments, the first time unit is a time unit in one or more periodicities, and the periodicity is determined based on exposure time of optical receiver units included in an optical receiving array in the detector.

In some embodiments, the method further includes: the processing apparatus adjusts the first time unit corresponding to the first optical receiver unit. The processing apparatus sends notification information to the detector, the light source, and the communication apparatus. The notification information is used to notify to adjust the first time unit corresponding to the first optical receiver unit.

Through the foregoing implementation, the adjustment includes increasing a quantity of time units corresponding to the first optical receiver unit. Through the foregoing implementation, duration of increasing the irradiation power of the light source can be increased, so that the detector can better collect the ROI information, and better monitor the user.

In some embodiments, the method further includes: the processing apparatus updates the correspondence between optical receiver units and time units based on an adjusted first time unit corresponding to the first optical receiver unit.

According to a second aspect, a monitoring method is provided. The method may be performed by a communication apparatus. The communication apparatus may be a communication device, or an apparatus, for example, a chip, that supports a function required by a communication device to implement the method. For example, the communication apparatus may be an electro-optic modulator, or a chip disposed in an electro-optic modulator and configured to implement a function of the electro-optic modulator, or another component configured to implement a function of an electro-opto modulator, or the like. The electro-opto modulator may be a pulse-driver (Photline) electro-optic modulator. An example in which the communication apparatus performs the method is used. The method includes: the communication apparatus receives notification information from a processing apparatus. The notification information is used to notify the communication apparatus to increase an irradiation power of a light source in a first region of interest (ROI) time unit. The communication apparatus controls the light source to increase the irradiation power in the first time unit.

In some embodiments, the first time unit is a time unit in one or more periodicities, and the periodicity is determined based on exposure time of optical receiver units included in an optical receiving array in a detector.

In some embodiments, when the first time unit is an ROI time unit in one periodicity, that the communication apparatus controls the light source to increase the irradiation power in the first time unit includes: the communication apparatus modulates a control signal in the first time unit, to determine a first modulated signal. The communication apparatus controls, based on the first modulated signal, the light source to increase the irradiation power.

In some embodiments, when the first time unit is ROI time units in a plurality of periodicities, that the communication apparatus controls the light source to increase the irradiation power in the first time unit includes: the communication apparatus determines, based on the first time unit, a second ROI time unit corresponding to each of the plurality of periodicities. The communication apparatus modulates a control signal in the second ROI time unit in each periodicity, to determine a second modulated signal. The communication apparatus controls, based on the second modulated signal, the light source to increase the irradiation power.

Through the foregoing implementation, the first ROI time unit in one periodicity is mapped to a plurality of periodicities, to further reduce light source intensity in one periodicity, avoiding stimulation to the user, and implementing monitoring on the user in a specific environment, for example, monitoring on the user in a sleep state.

In some embodiments, the method further includes: the communication apparatus receives a communication signal from the processing apparatus in a communication time unit. No intersection set exists between the communication time unit and the first time unit. The communication apparatus modulates the communication signal in the communication time unit, to determine a third modulated signal. The communication apparatus controls, based on the third modulated signal, the light source to increase the irradiation power.

In some embodiments, the method further includes: the communication apparatus receives the notification information from the processing apparatus. The notification information is used to notify to adjust the first ROI time unit corresponding to the first optical receiver unit. The communication apparatus adjusts, based on the notification information, the first ROI time unit corresponding to the first optical receiver unit.

According to a third aspect, an apparatus is provided. The apparatus includes corresponding units or modules for performing the method described in the first aspect or the second aspect. The units or the modules may be implemented through a hardware circuit, or through software, or through a combination of a hardware circuit and software.

According to a fourth aspect, an apparatus is provided. The apparatus includes a processor and an interface circuit. The processor is configured to communicate with another apparatus through the interface circuit, and perform the method described in the first aspect or the second aspect. One or more processors are included.

According to a fifth aspect, an apparatus is provided, including a processor coupled to a memory. The processor is configured to invoke a program stored in the memory, to perform the method described in the first aspect or the second aspect. The memory may be located in the apparatus, or may be located outside the apparatus. In addition, there may be one or more processors.

According to a sixth aspect, an apparatus is provided, including a processor and a memory. The memory is configured to store computer instructions. When the apparatus runs, the processor executes the computer instructions stored in the memory, to enable the apparatus to perform the method described in the first aspect or the second aspect.

According to a seventh aspect, a chip system is provided, including a processor configured to perform the method described in the first aspect or the second aspect.

According to an eighth aspect, a non-transitory computer-readable storage medium is provided. The non-transitory computer-readable storage medium stores instructions, and when the instructions are run on a communication apparatus, the method described in the first aspect or the second aspect is performed.

According to a ninth aspect, a computer program product is provided. The computer program product includes a computer program or instructions, and when the computer program or the instructions are executed by an apparatus, the method described in the first aspect or the second aspect is performed.

According to a tenth aspect, a monitoring system is provided, including: a processing apparatus, configured to determine, based on collected information about a user, a first optical receiver unit that is in a detector and that collects region of interest (ROI) information of the user, and determine, based on a correspondence between optical receiver units and time units, a first time unit corresponding to the first optical receiver unit; and a communication apparatus, configured to control a light source to increase an irradiation power in the first time unit.

Through the foregoing implementation, the system may control the light source to increase the irradiation power in the first time unit in which the ROI information is collected, and does not increase the irradiation power in other time units than the first time unit, so that a problem that the light source is excessively strong or excessively weak is solved, the ROI information of the user is collected in strong light, and interference to the user is small.

In some embodiments, the system further includes a detector, configured to collect the information about the user to determine the collected information. The collected information includes at least one of the following: reflected-light information of the user, thermal radiation information of the user, or image information of the user.

In some embodiments, the detector includes an optical receiver. The optical receiver includes at least one optical receiving array, the optical receiving array includes a plurality of optical receiver units. One periodicity is determined based on exposure time of the optical receiver units included in the optical receiving array.

In some embodiments, the detector further includes a complementary metal-oxide-semiconductor (CMOS) camera.

Through the foregoing implementation, because the CMOS camera has better ROI recognition performance, and the optical receiving array has better signal collection performance, the CMOS camera and the optical receiving array may be combined, to implement accurate ROI recognition and high signal collection sensitivity.

In some embodiments, the system further includes a light source configured to be controlled to increase the irradiation power in the first time unit.

In some embodiments, when determining, based on the collected information about the user, the first time unit that is in the detector and that collects the ROI information of the user, the processing apparatus is configured to: determine, based on the collected information, at least one of the following information of the user: depth information, light intensity information, or temperature information, where the depth information includes information about a distance between the user and the detector; and determine, based on at least one of the depth information, the light intensity information, or the temperature information of the user, the first optical receiver unit that is in the detector and that collects the ROI information of the user.

In some embodiments, when the first time unit is an ROI time unit in one periodicity, that the communication apparatus controls the light source to increase the irradiation power in the first time unit includes: modulating a control signal in the first time unit, to determine a first modulated signal; and controlling, based on the first modulated signal, the light source to increase the irradiation power.

In some embodiments, when the first time unit is ROI time units in a plurality of periodicities, that the communication apparatus controls the light source to increase the irradiation power in the first time unit includes: determining, based on the first time unit, a second ROI time unit corresponding to each of the plurality of periodicities; modulating a control signal in the second ROI time unit in each periodicity, to determine a second modulated signal; and controlling, based on the second modulated signal, the light source to increase the irradiation power.

In some embodiments, the processing apparatus is further configured to: determine a communication time unit based on the first time unit, and send a communication signal to the communication apparatus in the communication time unit. No intersection set exists between the first time unit and the communication time unit.

Through the foregoing implementation, the entire system further has power for communicating with the outside, and normal monitoring is not affected, thereby improving utilization of the communication apparatus.

In some embodiments, the communication apparatus is further configured to: modulate the communication signal in the communication time unit, to determine a third modulated signal; and control irradiation of the light source based on the third modulated signal.

In some embodiments, the processing apparatus is further configured to: adjust the first time unit corresponding to the first optical receiver unit, and send notification information to the detector, the light source, and the communication apparatus. The notification information is used to notify the detector, the light source, and the communication apparatus to adjust the first time unit corresponding to the first optical receiver unit.

In some embodiments, the detector, the light source, or the communication apparatus is further configured to adjust, based on the notification information, the first time unit corresponding to the first optical receiver unit.

### BRIEF DESCRIPTION OF DRAWINGS

FIG. 1 is a diagram of a monitoring method according to the embodiments;

FIG. 2 is a flowchart of a monitoring method according to the embodiments;

FIG. 3 is a diagram of integration or exposure time according to the embodiments;

FIG. 4 is a diagram of a PPM modulation scheme or an MPPM modulation scheme according to the embodiments;

FIG. 5 is a diagram of VOOK or MPPM modulation according to the embodiments;

FIG. 6 is a diagram of a post-change periodicity according to the embodiments;

FIG. 7 is a diagram of a monitoring system according to the embodiments;

FIG. 8 is another diagram of a monitoring system according to the embodiments;

FIG. 9 is a diagram of an apparatus according to the embodiments; and

FIG. 10 is another diagram of an apparatus according to the embodiments.

### DETAILED DESCRIPTION OF EMBODIMENTS

To make the objectives, solutions, and advantages clearer, the following further describes the embodiments in detail with reference to the accompanying drawings. Specific operation methods, function descriptions, and the like in method embodiments may also be applied to apparatus embodiments or system embodiments.

A working principle of a photoplethysmography (PPG) technology is to shine on skin of a user by using an external specific light source, collect reflected light of the skin of the user by using a photodetector, and then determine blood flow characteristics corresponding to the reflected light of the skin of the user with reference to artificial intelligence, deep learning algorithms, and the like, to deduce various physiological parameters of the user. The various physiological parameters include, but are not limited to, at least one of the following: blood pressure, respiration, blood volume, another circulation status of the user, or the like.

When light of a specific wavelength is irradiated on a surface of the skin of the user, a part of the light is transmitted through or absorbed by the skin of the user, and the other part of the light is reflected by the skin of the user. Absorption of light by muscles, bones, veins, and other connected tissues is basically unchanged, but absorption of light by arteries varies with characteristics of blood flow in the arteries. In other words, different characteristics of the blood flow in the arteries cause different absorption of light by the arteries, leading to different reflected light of the skin of the user. Therefore, blood flow characteristics of the user may be deduced based on different reflected light on the surface of the skin of the user.

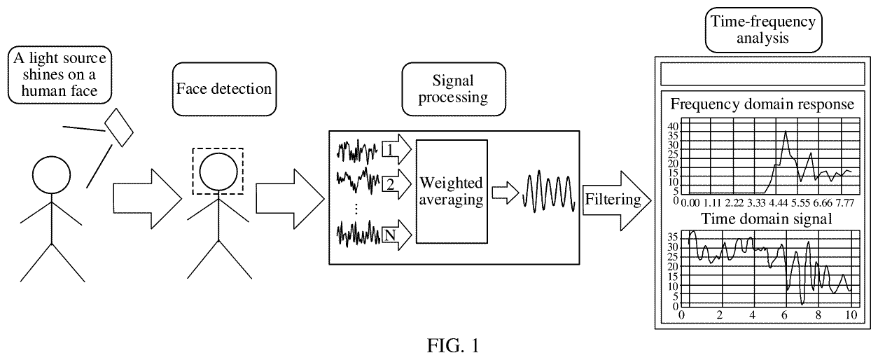

As shown in FIG. 1, in some embodiments, an external specific light source may be used to shine on a face of a user, and then a camera is used to collect reflected light of the face of the user. Blood flow characteristics of the user are deduced based on the collected reflected light of the face of the user, and heartbeat and respiratory rates of the user are further deduced. For example, signal processing may be performed on the collected reflected light of the face of the user. The processing includes, but is not limited to, weighted averaging, filtering, time-frequency analysis, and the like. Through the foregoing processing, the heartbeat rate, the respiratory rate, and the like of the user can be obtained. This solution has the following disadvantages: the external specific light source shines on the face of the user, and a monitoring effect is poor when light is insufficient. However, if light intensity of the external light source is too strong, user experience is poor, for example, light is harsh to the user.

The embodiments provide a monitoring method. The method may be applied to a scenario in which physiological parameters of a user, for example, blood pressure, respiration, blood volume, and another circulation status of the user, are monitored. The method includes: A light source shines on the user. A detector collects information about the user, to determine collected information. A processing apparatus determines a region of interest (ROI) based on the collected information. Optionally, the ROI may be external bare skin or the like of the user. The detector includes a plurality of optical receiver units, and an optical receiver unit for collecting the ROI may be determined, which may be referred to as an ROI optical receiver unit. Exposure time of the ROI optical receiver unit is further determined, which may be referred to as an ROI time unit. The light source is controlled to increase an irradiation power in the ROI time unit, to resolve a problem of a poor monitoring effect caused by insufficient light. However, the light source does not increase the irradiation power in a non-ROI time unit, so that a problem of poor user experience caused by excessively strong light intensity of an external light source can also be resolved.

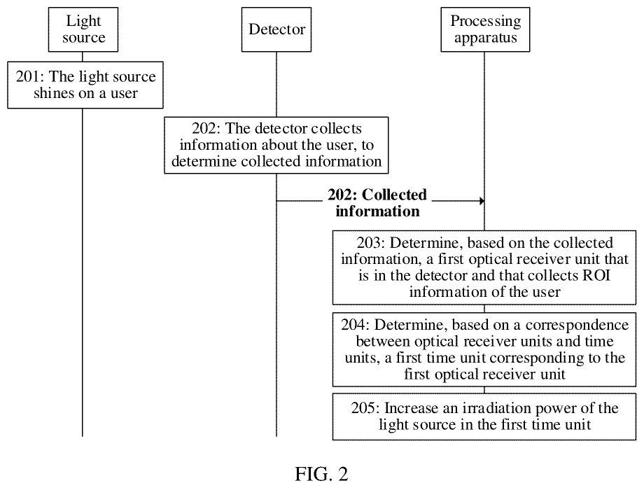

As shown in FIG. 2, a flowchart of a monitoring method is provided, including the following steps:

Step 201: A light source shines on a user.

The light source may be a light emitting diode (LED), a low-power laser, or the like. The light source may shine toward a direction of the user. The user may also be referred to as a subject.

Step 202: A detector collects information about the user, to determine collected information, where the collected information includes at least one of the following: reflected-light information of the user, thermal radiation information of the user, image information of the user, or the like; and sends the collected information to a processing apparatus.

The detector includes a plurality of optical receiver units, and the optical receiver units may receive optical information of the user. The optical information includes, but is not limited to, at least one of the following: reflected light of the user, thermal radiation of the user, or the like. The thermal radiation of the user is a type of light information. Considering that a normal temperature of a human body generally does not exceed 40° C., thermal radiation can be radiated by invisible infrared light. In other words, the collected thermal radiation information of the user may be collected infrared light information or the like. Alternatively, the detector may include a camera, and the camera may be used to collect the image information of the user, and the like.

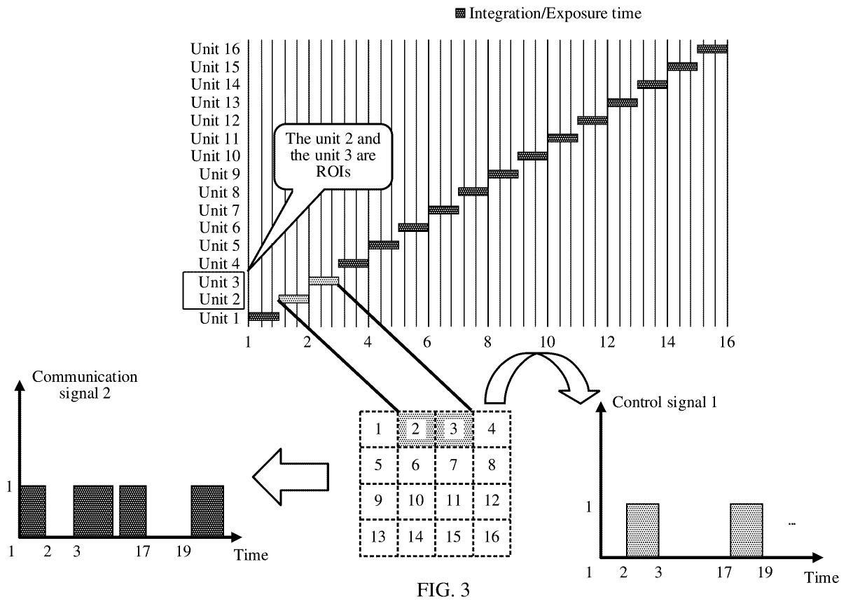

Optionally, the detector includes at least one optical receiving array, and each optical receiving array includes a plurality of optical receiver units. The optical receiver units included in each optical receiving array are exposed periodically. For example, as shown in FIG. 3, an optical receiving array includes 16 optical receiver units, and the optical receiver units may be referred to as units for short. The 16 optical receiver units may be exposed in sequence by time. For example, the 16 optical receiver units correspond to 16 time units, and each optical receiver unit is exposed in a corresponding time unit. For example, an optical receiver unit 1 is exposed in a time unit 1, and collects the information about the user. An optical receiver unit 2 is exposed in a time unit 2, and collects the information about the user. In a sequential and cyclic manner, an optical receiver unit 16 is exposed in a time unit 16, and collects the information about the user. A unit of the time unit may be radio frame, subframe, slot, mini-slot, a symbol, or the like. Exposure of each optical receiver unit in a corresponding time unit may also be referred to as integration of each optical receiver unit in a corresponding time unit.

Step 203: The processing apparatus determines, based on the collected information, a first optical receiver unit that is in the detector and that collects ROI information of the user.

For example, the processing apparatus may determine at least one of the following information of the user based on the collected information: depth information, light intensity information, or temperature information. The depth information includes information about a distance between the user and the detector, the light intensity information includes color information of the user, and the color information includes red green blue (RGB) information. The depth information and/or the light intensity information of the user may be determined based on the reflected light of the user, or may be determined based on the image information of the user. A specific determining method includes, but is not limited to, artificial intelligence, deep learning algorithms, and the like. The temperature information of the user may be determined based on the thermal radiation information of the user, or may be determined based on the image information of the user. Based on at least one of the depth information, the light intensity information, the temperature information, or the like of the user, the processing apparatus determines the first optical receiver unit that is in the detector and that collects the ROI information of the user. For example, the processing apparatus determines the ROI of the user based on at least one of the depth information, the light intensity information, the temperature information, and the like of the user. The ROI is a bare skin region of the user, and includes, but is not limited to, a region such as the face, a hand, or an arm of the user. An example in which the ROI is a face region of the user is used. The processing apparatus may determine a contour of the user based on the determined depth information; determine, in the contour of the user, a region that meets a human face contour, which is referred to as a first region; further determine whether light intensity information corresponding to the first region meets a requirement of a human skin color; if the light intensity information meets the requirement of the human skin color, further determine whether temperature information corresponding to the first region meets a requirement of a normal temperature of the human body; and if the temperature information meets the requirement of the normal temperature of the human body, determine that the first region is the face region of the user and is the ROI. The detector determines, in the plurality of optical receiver units included, the optical receiver unit for collecting the ROI information, which is referred to as the first optical receiver unit. The first optical receiver unit may include one or more optical receiver units. For example, in an example in FIG. 3, an example in which the first optical receiver unit includes an optical receiver unit 2 and an optical receiver unit 3 is used. In other words, the optical receiver unit 2 and the optical receiver unit 3 of the detector are used to collect the ROI information.

Step 204: The processing apparatus determines, based on a correspondence between optical receiver units and time units, a first time unit corresponding to the first optical receiver unit.

As described above, there is a correspondence between the optical receiver units included in the detector and the time units, and each optical receiver unit is exposed in a time unit having correspondence with the optical receiver unit. The processing apparatus may determine, based on the correspondence between optical receiver units and time units, a time unit having correspondence with the first optical receiver unit for collecting the ROI information, and the time unit may be referred to as the first time unit. The first time unit may include one or more time units. For example, in the example in FIG. 3, the first time unit includes the time unit 2 and a time unit 3. Because the first optical receiver unit is configured to collect the ROI information, the first optical receiver unit may also be referred to as an ROI optical receiver unit. There is a correspondence between the first time unit and the first optical receiver unit, so that the first time unit may also be referred to as an ROI time unit.

Step 205: The processing apparatus increases an irradiation power of the light source in the first time unit.

For example, the processing apparatus may directly control the light source, and increase the irradiation power of the light source in the first time unit. For example, the processing apparatus may send notification information to the light source, to notify the light source to increase the irradiation power in the first time unit. Alternatively, the processing apparatus may control the communication apparatus to increase the irradiation power of the light source in the first time unit. For example, the processing apparatus may send control information to the communication apparatus. The control information is used to notify the communication apparatus to increase the irradiation power of the light source in the first time unit. The communication apparatus may control, based on the control information, the light source to increase the irradiation power. For a process in which the communication apparatus controls the light source to increase the irradiation power, refer to the following descriptions. Optionally, the light source may increase the irradiation power in a direction of a position of the user. That the irradiation power of the light source is increased in the first time unit is described as follows:

in the first time unit, the light source shines outward at a preset power. Optionally, for other time units than the first time unit, the light source is turned off. Alternatively, in the first time unit, the light source shines outward at a first power. Optionally, for other time units than the first time unit, the light source shines outward at a second power. The first power is greater than the second power.

Optionally, the first time unit is a time unit in one or more periodicities, and the periodicity is determined based on exposure time of the optical receiver units included in the detector. For example, a photodetector includes at least one optical receiving array, and one optical receiving array includes a plurality of optical receiver units. The optical receiver units included in each optical receiving array are exposed in sequence, and one periodicity may be defined as time for all optical receiver units in an optical receiving array to be exposed once. In the example in FIG. 3, one periodicity may be 16 time units.

In some embodiments, when the first time unit is an ROI time unit in one periodicity, that the communication apparatus controls the light source to increase the irradiation power in the first time unit includes: the communication apparatus modulates the control signal in the first time unit, to determine a first modulated signal. For example, the control apparatus may modulate a control signal by using a first modulation scheme, to determine the first modulated signal. Optionally, the control signal may be generated by the communication apparatus, or may be generated by the processing apparatus and notified to the communication apparatus. Optionally, the first modulation scheme may be notified by the processing apparatus to the communication apparatus, or may be preset, or the first modulation scheme is related to the control signal or the first time unit, or the like. The communication apparatus controls, based on the first modulated signal, the light source to increase the irradiation power.

For example, the processing apparatus recognizes an ROI by using user information collected by the detector, maps the ROI from space to time, and loads the control signal to a time unit corresponding to the ROI, such as the first time unit. In other words, the processing apparatus may generate the control signal in the first time unit, and send the control signal to the communication apparatus. The communication apparatus modulates the control signal in the first time unit by using the first modulation scheme, to determine the first modulated signal. Optionally, the control signal may be formed by a high electrical level, or may be formed by a binary digit “1”. Optionally, the first modulation scheme includes, but is not limited to, any one of the following: on-off keying (OOK), variable on-off keying (VOOK), pulse position modulation (PPM), multiple pulse position modulation (MPPM), or the like.

The VOOK modulation scheme is used as an example. The VOOK modulation scheme is essentially an OOK modulation scheme with a variable duty cycle. Optionally, a duty cycle of a VOOK modulated signal, such as the first modulated signal, may be less than or equal to 0.5. The duty cycle may be, in codewords corresponding to a time unit, a ratio of a quantity of codewords “1” to a quantity of all codewords corresponding to the time unit. As shown in Table 1, the duty cycle, communication efficiency, and the VOOK modulated signal are described. In Table 1, d represents an original codeword, and the original codeword may be a codeword 0, a codeword 1, or the like. It should be noted that, in the embodiments, the original codeword may be a control signal, and is formed by a high electrical level or a binary digit 1. In an example of Table 1, after VOOK modulation is performed on the original codeword, a quantity of codewords is ten. For example, in the following Table 1, when the duty cycle is 0.5, the codeword obtained through the VOOK modulation is “dddddddddd”. In the embodiments, the original codeword is a control signal, and a high electrical level is 1. When the duty cycle is 0.5, a codeword obtained through the VOOK modulation is “1111111111”.

Optionally, the communication apparatus may send a modulated signal, for example, the foregoing “1111111111”, to the light source in the first time unit, and control the light source to increase the irradiation power of the light source in the first time unit. An example in which the first time unit is the time unit 2 and the time unit 3 is used. The processing apparatus separately generates a control signal in each of the time unit 2 and the time unit 3, where the control signal may be a binary digit 1; and separately sends the control signal to the communication apparatus in the time unit 2 and the time unit 3. The communication apparatus modulates the control signal in the time unit 2, to determine a first modulated signal. For example, the first modulated signal may be “1111111111”. The communication apparatus sends the first modulated signal to the light source, and the light source increases the irradiation power of the light source in the time unit 2 based on the first modulated signal. A procedure in which the communication apparatus processes the control signal corresponding to the time unit 3 is similar to the foregoing procedure in which the communication apparatus processes the control signal corresponding to the time unit 2, and details are not described again. When receiving the first modulated signal in the time unit 2 or the time unit 3, the light source divides the time unit 2 or the time unit 3 into smaller time units. For example, the time unit is divided into ten smaller time units. In this case, if a modulated signal corresponding to each of the smaller time units is “1”, the light source emits light; otherwise, the light source does not emit light. Alternatively, if a modulated signal corresponding to each of the smaller time units is “1”, the light source emits light at a first power; otherwise, the light source emits light at a second power. The first power is greater than the second power. An example in which a unit of the time unit is slot is used. In the foregoing example, the first modulated signal is “1111111111”, and a slot 2 or a slot 3 may be divided into ten parts, where each part corresponds to a 0.1 slot. In each 0.1 slot, if a modulated signal corresponding to the 0.1 slot is 1, the light source emits light, or emits light at the first power; or if a modulated signal corresponding to the 0.1 slot is 0, the light source does not emit light, or emits light at the second power, or the like. Subsequently, in other modulation schemes, a processing procedure of the light source is similar, and a difference lies in that for a same control signal, different modulation schemes are used, and obtained first modulated signals may be different.

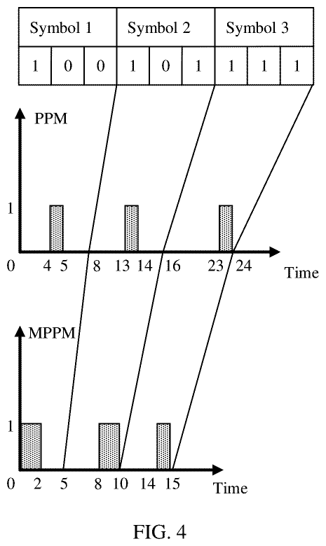

The MPPM modulation scheme is used as an example. The essence of the MPPM is to map a PPM symbol of k bits into a symbol of M bits, where 2k>M>k. As shown in FIG. 4, in the MPPM modulation scheme, a 3-bit symbol is mapped into a 5-bit symbol. However, in the PPM modulation scheme, the 3-bit symbol is mapped into an 8-bit symbol. Therefore, efficiency of the MPPM modulation is higher. A processing procedure performed by the communication apparatus by using the MPPM modulation scheme is similar to that by using the foregoing VOOK modulation scheme. A difference lies in that in the VOOK modulation scheme, the communication apparatus modulates the control signal into the first modulated signal by using the VOOK modulation scheme. In the MPPM modulation scheme, the communication apparatus modulates a control signal into the first modulated signal, or the like by using the MPPM modulation scheme. In the MPPM modulated method, for a processing procedure after the control signal is modulated into the first modulated signal, reference may be made to the foregoing VOOK modulation scheme.

In another implementation, when the first time unit is ROI time units in a plurality of periodicities, that the communication apparatus controls the light source to increase the irradiation power in the first time unit includes: the communication apparatus determines, based on the first time unit, a second ROI time unit corresponding to each of the plurality of periodicities. Optionally, quantities of second ROI time units corresponding to different periodicities are the same or different. The second ROI time unit may include one or more time units. The process may be described as follows: The communication apparatus maps the first time unit, such as the ROI time unit, to L0 periodicities, where L0 is an integer greater than 1. The communication apparatus modulates the control signal in the second ROI time unit in each periodicity, to determine a second modulated signal; and the communication apparatus controls, based on the second modulated signal, the light source to increase the irradiation power.

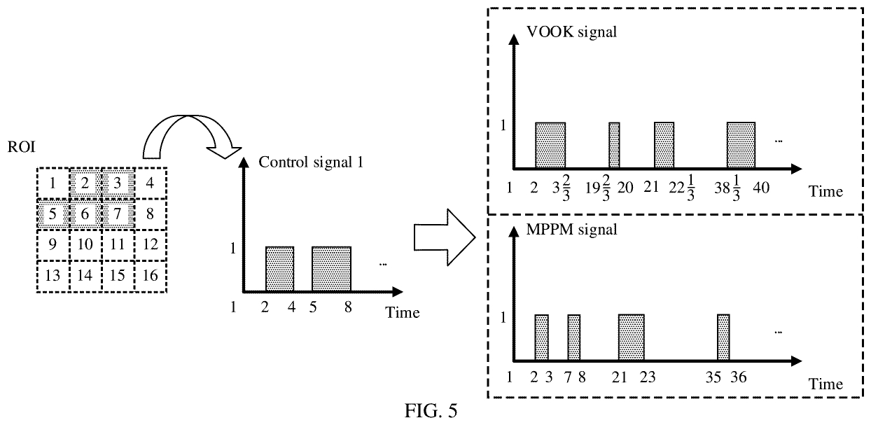

For example, as shown in FIG. 5, the determined first time unit (such as the ROI time unit) includes five slots: a slot 2, a slot 3, and a slot 5 to a slot 7. According to the foregoing first implementation, the communication apparatus controls the light source to increase the irradiation power in the foregoing five slots. However, in the foregoing second implementation, the five slots may be mapped to three periodicities. For example, a quantity of second ROI time units in each periodicity is the same. For example, there are 5/3 slots in each periodicity, and the light source is controlled to increase the irradiation power. The 5/3 slots in each periodicity are the foregoing second ROI time units. Optionally, a union set of 5/3 slots corresponding to each of the three periodicities may exactly cover the foregoing five slots. An example in which the periodicity is 16 slots is used. In the first periodicity, the determined second ROI time unit is the slot 2 to a slot

$$3 \frac{2}{3} .$$

In the second periodicity, the determined second ROI time unit is a slot

$$19 \frac{2}{3}$$

to a slot 20 and a slot 21 to a slot

$$22 \frac{1}{3} .$$

In the third periodicity, the determined second ROI time unit is a slot

$$38 \frac{1}{3}$$

to a slot 40, and so on. For the mapping manner, refer to the VOOK modulation scheme in FIG. 6. Alternatively, a quantity of second ROI time units in each periodicity may be different. As shown in FIG. 6, five slots included in the ROI time unit are mapped to three periodicities. Two slots are mapped to each of the first periodicity and the second periodicity. One slot is mapped to the third periodicity. For the modulation scheme, refer to the MPPM modulation scheme in FIG. 6. For example, in the first periodicity, the two slots are a slot 2 and a slot 7. In the second periodicity, the two slots are a slot 21 and a slot 22. In the third periodicity, the one slot is a slot 35. In this mapping manner, a union set of slots mapped to the three periodicities also covers the foregoing five slots.

Through the foregoing implementation, an ROI time unit in one periodicity can be mapped to ROI time units in a plurality of periodicities, so that light intensity of the light source in each periodicity is reduced, and remote physical sign monitoring can be implemented without perception of human eyes, for example, when the user is in a sleep state.

Optionally, the processing apparatus may further determine a communication time unit based on the first time unit. No intersection set exists between the communication time unit and the first time unit. For example, as shown in FIG. 3, one periodicity includes 16 slots, and the first time unit is a slot 2 and a slot 3. In this case, the communication time unit may be a slot 1, a slot 4 to a slot 16, or the like. Optionally, the first time unit may be referred to as an ROI time unit, and the communication time unit may be referred to as a non-ROI time unit. The processing apparatus may send a communication signal to the communication apparatus in the communication time unit. The communication apparatus modulates a communication signal in the communication time unit, to determine a third modulated signal; and the communication apparatus controls irradiation of the light source based on the third modulated signal. Optionally, the communication signal may be modulated by using a modulation scheme such as the VOOK or MPPM. After being modulated, the communication signal still needs to be loaded to the non-ROI time unit. In this implementation, the communication signal is loaded in the non-ROI time unit, so that the entire system has a capability of communicating with the outside. Optionally, a communication time unit in the foregoing one periodicity may be mapped to a communication time unit in L1 periodicities. The communication time unit in the L1 periodicities may cover the communication time unit in one periodicity. L1 is an integer greater than 1, and a value of L1 may be the same as or different from a value of L0 above. For a specific process of mapping the communication time unit in one periodicity to the communication time unit in the L1 periodicities, refer to the foregoing process of mapping the ROI time unit in one periodicity to the ROI time unit in the L0 periodicities. Details are not described again.

For example, the first time unit is referred to as an ROI slot, and the communication time unit is referred to as a non-ROI slot. A signal duty cycle in an ROI slot is denoted as c₀; a signal duty cycle in a non-ROI slot is denoted as c₁; a maximum duty cycle acceptable by a system in a periodicity is denoted as cₘₐₓ; a quantity of ROI slots in a current periodicity is denoted as N₀, and a quantity of non-ROI slots in the current periodicity is denoted as N₁. In this case, the following is met:

$${c}_{max} \geq \frac{{N}_{o} {c}_{0} + {N}_{1} {c}_{1}}{{N}_{0} + {N}_{1}}$$

Optionally, the maximum duty cycle cₘₐₓ acceptable by the system and a maximum duty cycle c₀ of a control signal in a ROI slot may be determined based on an environment and a requirement, and c₀ and cₘₐₓ meet c₀≤cₘₐₓ, and a duty cycle c₁ of a communication signal in a non-ROI slot meets:

$${c}_{1} = \frac{( {N}_{o} + {N}_{1} ) {c}_{max} - {N}_{o} {c}_{0}}{{N}_{1}}$$

It is set that an ROI slot in a periodicity is mapped to an ROI slot in L0 periodicities, and a non-ROI slot in a periodicity is mapped to an ROI slot in L1 periodicities. In this case, the duty cycle of the control signal meets:

$$\frac{1}{{L}_{0}} \geq {c}_{0} > \frac{1}{{L}_{0} + 1}$$

The duty cycle of the communication signal meets:

$$\frac{1}{{L}_{1}} \geq {c}_{1} > \frac{1}{{L}_{1} + 1}$$

Optionally, the processing apparatus may further adjust the first time unit corresponding to the first optical receiver unit. The processing apparatus sends notification information to the detector, the light source, the communication apparatus, and the like. The notification information is used to notify to adjust the first time unit corresponding to the first optical receiver unit. The detector, the light source, the communication apparatus, and the like may adjust, based on the notification information, the first time unit corresponding to the first optical receiver unit. For example, a quantity of first time units corresponding to the first optical receiver unit may be adjusted in an increasing direction, or may be adjusted in a decreasing direction, or a quantity of first time units corresponding to the first optical receiver unit may be first increased, and then decreased, or a quantity of first time units corresponding to the first optical receiver unit may be first decreased, and then increased.

For example, an optical receiving array in the detector includes 16 optical receiver units, and each optical receiver unit corresponds to one time unit. The optical receiver unit 2 and the optical receiver unit 3 are determined as first optical receiver units, and are used to collect ROI information. For example, as shown in FIG. 3, in the foregoing implementation, the optical receiver unit 2 corresponds to the time unit 2, and the optical receiver unit 3 corresponds to the time unit 3. The processing apparatus may adjust time units corresponding to the optical receiver 2 and the optical receiver 3. For example, as shown in FIG. 6, time units corresponding to the optical receiver unit 2 are adjusted to a time unit 2 and a time unit 3, and time units corresponding to the unit 3 are adjusted to a time unit 4 and a time unit 5. Each optical receiver unit is exposed or integrated in a corresponding time unit, and is used to collect the information about the user. Therefore, in the foregoing implementation, increasing a quantity of time units corresponding to the ROI optical receiver unit may increase exposure or integration time corresponding to the ROI optical receiver unit, so that the ROI optical receiver unit is used to collect information corresponding to the ROI, thereby improving monitoring accuracy.

Optionally, the processing apparatus may further update the correspondence between optical receiver units and time units based on an adjusted first time unit corresponding to the first optical receiver unit. For example, in the foregoing implementation, as shown in FIG. 3, each optical receiver unit corresponds to one time unit, the optical receiving array in the detector includes 16 optical receiver units, and one periodicity includes 16 time units. A quantity of time units corresponding to the ROI optical receiver unit is increased. For example, in the foregoing example, that one time unit corresponds to each of the optical receiver unit 2 and the optical receiver unit 3 is adjusted to that two time units correspond to each of the optical receiver unit 2 and the optical receiver unit 3. In this case, the entire periodicity is changed from 16 time units to 18 time units, and the correspondence between optical receiver units and time units is changed as follows: the optical receiver unit 1 corresponds to a time unit 1, the optical receiver unit 2 corresponds to the time unit 2 and the time unit 3, the optical receiver unit 3 corresponds to the time unit 4 and the time unit 5, each of an optical receiver unit 4 to the optical receiver unit 16 corresponds to one time unit, and time units corresponding to the optical receiver unit 4 to the optical receiver unit 16 are sequentially a time unit 6 to a time unit 18. Optionally, after a quantity of ROI time units is increased, a length of the entire periodicity may be less than twice a length of the original periodicity. For example, in the foregoing example, an adjusted periodicity is 18/16=1.25 times the original periodicity. No difference in an order of magnitude lies in a length of the adjusted periodicity and the length of the original periodicity, and sampling frequency is not significantly reduced.

In the foregoing implementation, exposure or integration time of the ROI optical receiver unit is properly increased, so that quality of information collected by the detector is improved without significantly affecting a frame rate or the sampling frequency. In addition, in the foregoing manner, that the control signal is distributed in a large quantity of periodicities after adjustment can be avoided, and complexity of an image processing algorithm and a signal processing algorithm can be reduced.

The method in the procedure in FIG. 2 may be applied to a scenario in which physiological parameters of the user are monitored. For example, after step 205, the method may further include: The first optical receiver unit, such as the ROI time unit, in the detector, collects the ROI information of the user at corresponding exposure time, and sends the collected ROI information to the processing apparatus. The processing apparatus determines blood flow characteristics of the user based on the ROI information, and deduces various physiological parameters of the user based on the blood flow characteristics of the user. The physiological parameters include, but are not limited to, respiration, blood pressure, blood volume, another circulation status, or the like. A process of deducing the physiological parameters of the user based on the ROI information includes, but is not limited to, signal processing (for example, filtering or weighted averaging), a deep learning algorithm, an artificial intelligence algorithm, or the like.

Optionally, in addition to the optical receiver unit, the detector further includes a complementary metal-oxide-semiconductor (CMOS) camera. The CMOS camera and the optical receiving array are combined, and are configured to perform target recognition and tracking. After the ROI is recognized, the optical receiver unit is used to collect a signal in the ROI. Optionally, the optical receiver unit and the CMOS camera may form a binocular system, to obtain three-dimensional (3D) depth information of the user. For example, the optical receiver unit and the CMOS camera may collect the information about the user, to determine the collected information. The collected information includes at least one of the following: reflected-light information of the user, thermal radiation information of the user, image information of the user, or the like. The CMOS camera may determine the ROI based on the collected information. In other words, in the embodiments, an entity for “determining the ROI based on the collected information” may be a processing apparatus in the CMOS camera. A processing apparatus that performs the following process may be the processing apparatus in the CMOS camera, or another processing apparatus. The processing apparatus determines, based on a correspondence between optical receiver units and time units, the first time unit corresponding to the first optical receiver unit; and the processing apparatus controls the light source to increase the irradiation power in the first time unit. Optionally, the optical receiver unit may collect the information about the user in the first time unit, and send the collected information to the processing apparatus. The processing apparatus may also be the processing apparatus in the CMOS camera, another processing apparatus, or the like. The processing apparatus determines the blood flow characteristics of the user based on the collected information, and deduces various physiological parameters of the user based on the blood flow characteristics of the user.

Optionally, the CMOS camera includes a photoelectric sensor, and a resolution of the CMOS camera is determined by a quantity of photosensitive elements in the photoelectric sensor. One photosensitive element corresponds to one pixel. Therefore, a larger resolution indicates more photosensitive elements and higher costs. In the embodiments, the resolution of the CMOS camera is higher than that of the optical receiver unit. For example, one optical receiver unit may correspond to N*N pixels of the CMOS camera, where Nis an integer greater than 5. Because the resolution of the CMOS camera is greater than that of the optical receiver unit, the CMOS camera has a better recognition characteristic.

In the foregoing implementation, because the CMOS camera has better ROI recognition performance, and the optical receiver unit has better signal collection performance, the CMOS camera and the optical receiver unit may be combined to meet requirements such as a high sampling rate and high ROI recognition. It should be noted that the foregoing combination of the optical receiver unit and the CMOS camera is merely an example for description, and is not intended to limit the embodiments. For example, the optical receiver unit may be combined with other optical systems, such as a perspective lens and/or a micro-electro-mechanical system (MEMS) mirror reflector, to improve signal collection sensitivity.

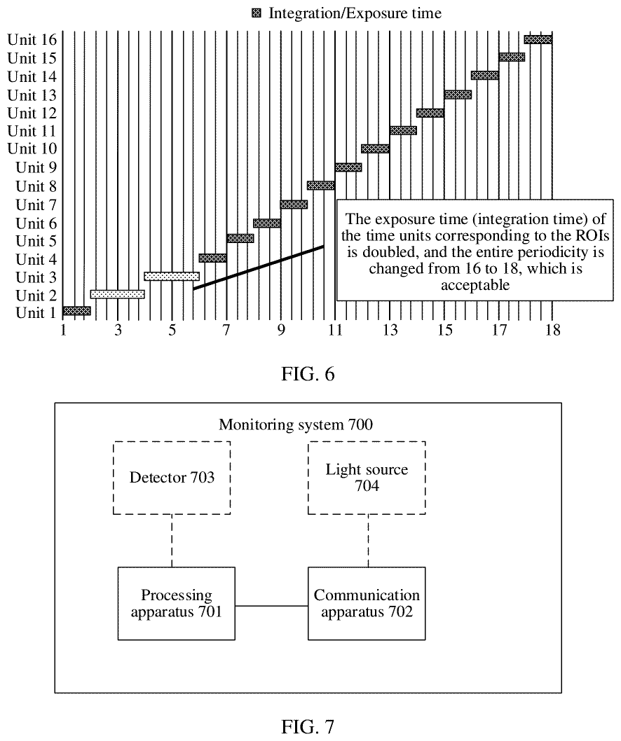

As shown in FIG. 7, a monitoring system 700 is further provided, including at least a processing apparatus 701 and a communication apparatus 702.

The processing apparatus 701 is configured to determine, based on collected information about a user, a first optical receiver unit that is in a detector and that collects ROI information of the user, and determine, based on a correspondence between optical receiver units and time units, a first time unit corresponding to the first optical receiver unit. The communication apparatus 702 is configured to control a light source to increase an irradiation power in the first time unit.

Optionally, the system 700 may further include a detector 703 configured to collect the information about the user to determine the collected information. The collected information includes at least one of the following: reflected-light information of the user, thermal radiation information of the user, or image information of the user. The detector 703 includes an optical receiving array. Optionally, the detector may further include a CMOS camera. Optionally, the system 700 may further include a light source 704 configured to be controlled to increase the irradiation power in the first time unit.

For a specific execution process of each component in the monitoring system 700, refer to the descriptions of the foregoing method. Details are not described again. The components in the monitoring system 700 may be integrated into one product, or may be separately deployed in different products. The monitoring system 700 may be a part or all of a current product.

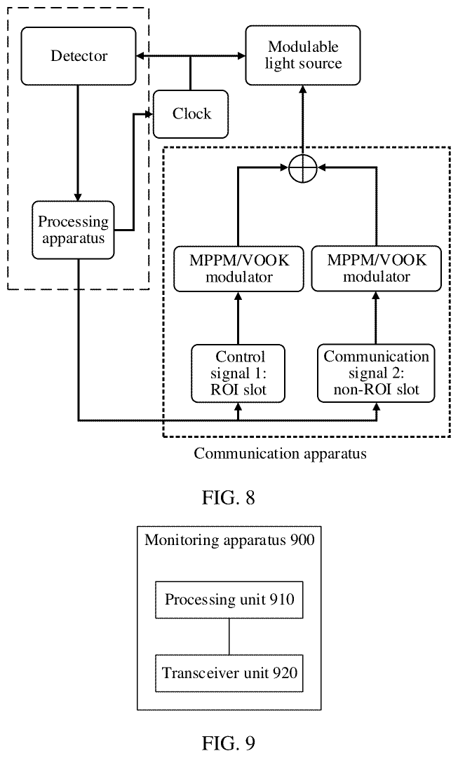

As shown in FIG. 8, a specific example of a monitoring system is provided, including: a detector collects information about a user, to determine collected information, and sends the collected information to a processing apparatus. The processing apparatus determines an ROI based on the collected information, and determines an ROI slot corresponding to the ROI. The processing apparatus generates a control signal, and sends the control signal to a communication apparatus. The communication apparatus loads the control signal to the ROI slot, modulates the control signal in the ROI slot by using a modulator, and sends a signal obtained through the modulation (or referred to as a modulated signal) to a light source. Optionally, the light source may be referred to as a modulable light source. The light source controls, based on the modulated signal, the light source to increase an irradiation power. Optionally, the processing apparatus may further determine a non-ROI slot based on the ROI slot, where no intersection exists between the ROI slot and the non-ROI slot. The processing apparatus sends a communication signal to the communication apparatus. The communication apparatus loads the communication signal in the non-ROI slot, modulates the communication signal by using the modulator, and sends a modulated signal to the light source. The light source emits light based on the modulated signal. Optionally, the modulator may be an MPPM modulator or a VOOK modulator. The control signal may be referred to as a control signal 1, and the communication signal may be referred to as a communication signal 2. Optionally, the detector, the processing apparatus, the modulable light source, and the like may use a same clock signal clock. The clock signal may be generated by the processing apparatus, to implement clock synchronization between a transmit end of the light source and a receive end of the detector. Optionally, an operating frequency band of the detector, or referred to as a light-perceived frequency band, may include any one of the following frequency bands: visible light (360 nm to 830 nm), near-infrared light (830 nm to 1550 nm), medium-infrared light (6 um to 14 um), or the like. An operating frequency band of the modulable light source may be visible light, near-infrared light (360 nm to 1550 nm), or the like. Optionally, the detector may be a Hamamatsu silicon photodiode array S4111-35Q, a Hamamatsu silicon avalanche photodiode (APD) array S8550-02, a Hamamatsu CMOS linear array image sensor S11639-01, or the like. The light source may be an OSRAM LED-SFH5701A01 or the like. The processing apparatus may be a personal computer processing apparatus series of Intel, or AMD, or a mobile phone processing series of Apple, Huawei, or Qualcomm, or the like. The communication apparatus may be a pulse-driver (Photline) electro-optic modulator NIR-MX800-LN-10, or the like.

By using the foregoing monitoring system, remote physical sign monitoring of the user can be implemented without perception of human eyes. In addition, the monitoring system further has a capability of communicating with the outside.

It may be understood that, to implement the functions in the foregoing embodiments, the processing apparatus and the communication apparatus end include corresponding hardware structures and/or software modules for performing the functions. A person skilled in the art should be easily aware that, in the embodiments, the units and method steps in the examples described with reference to embodiments can be implemented by hardware or a combination of hardware and computer software. Whether a function is performed by hardware or hardware driven by computer software depends on particular scenarios and design constraint conditions of the solutions.

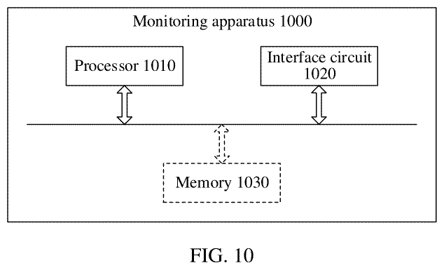

FIG. 9 and FIG. 10 are diagrams of structures of possible monitoring apparatuses according to embodiments. The monitoring apparatuses may be configured to implement functions of the processing apparatus or the communication apparatus in the foregoing method embodiments. Therefore, beneficial effects of the foregoing method embodiments can also be implemented.

As shown in FIG. 9, a monitoring apparatus 900 includes a processing unit 910 and a transceiver unit 920. The monitoring apparatus 900 is configured to implement the functions of the processing apparatus or the communication apparatus in the method embodiments shown in FIG. 2.

When the monitoring apparatus 900 is configured to implement the functions of the processing apparatus in the method embodiments shown in FIG. 2, the transceiver unit 920 is configured to receive collected information from a detector. The collected information includes at least one of the following: reflected-light information of a user, thermal radiation information of the user, or image information of the user. The processing unit 910 is configured to determine, based on the collected information, a first optical receiver unit that is in the detector and that collects region of interest (ROI) information of the user, determine, based on a correspondence between optical receiver units and time units, a first time unit corresponding to the first optical receiver unit; and increase an irradiation power of a light source in the first time unit.

When the monitoring apparatus 900 is configured to implement the functions of the communication apparatus in the method embodiments shown in FIG. 2, the transceiver unit 920 is configured to receive notification information from the processing apparatus, where the notification information is used to notify the communication apparatus to increase an irradiation power of a light source in a first region of interest (ROI) time unit; and the processing unit 910 is configured to control the light source to increase the irradiation power in the first time unit.

For more detailed descriptions of the processing unit 910 and the transceiver unit 920, directly refer to related descriptions of the method embodiment shown in FIG. 2. Details are not described herein again.

As shown in FIG. 10, a monitoring apparatus 1000 includes a processor 1010 and an interface circuit 1020. The processor 1010 and the interface circuit 1020 are coupled to each other. It may be understood that the interface circuit 1020 may be a transceiver or an input/output interface. Optionally, the monitoring apparatus 1000 may further include a memory 1030, configured to: store instructions executed by the processor 1010, or store input data required by the processor 1010 to run the instructions, or store data generated after the processor 1010 runs the instructions.

When the monitoring apparatus 1000 is configured to implement the method shown in FIG. 2, the processor 1010 is configured to implement the functions of the processing unit 910, and the interface circuit 1020 is configured to implement the functions of the transceiver unit 920.

When the communication apparatus is a chip or a module used in a processing apparatus, the chip or the module of the processing apparatus implements the functions of the processing apparatus in the foregoing method embodiments. The chip or the module of the processing apparatus receives information from another module (for example, a radio frequency module or an antenna) in the processing apparatus, where the information is sent by the communication apparatus to the processing apparatus; or the chip or the module of the processing apparatus sends information to another module (for example, a radio frequency module or an antenna) in the processing apparatus, where the information is sent by the processing apparatus to the communication apparatus.

When the communication apparatus is a chip or a module used in a communication apparatus, the chip or the module of the communication apparatus implements a function of the communication apparatus in the foregoing method embodiments. The chip or the module of the communication apparatus receives information from another module (for example, a radio frequency module or an antenna) in the communication apparatus, where the information is sent by the communication apparatus to a processing apparatus; or the chip or the module of the communication apparatus sends information to another module (for example, a radio frequency module or an antenna) in the communication apparatus, where the information is sent by the communication apparatus to a processing apparatus.

It may be understood that the processor in embodiments may be a central processing unit (CPU), or may be another general-purpose processor, a digital signal processor (DSP), an application-specific integrated circuit (ASIC), a field programmable gate array (FPGA) or another programmable logic device, a transistor logic device, a hardware component, or any combination thereof. The general-purpose processor may be a microprocessor or any regular processor or the like.

The method steps in embodiments may be implemented in a hardware manner, or may be implemented in a manner of executing software instructions by a processor. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk, a removable hard disk, a CD-ROM, or any other form of storage medium well-known in the art. For example, a storage medium is coupled to a processor, so that the processor can read information from the storage medium and write information into the storage medium. Further, the storage medium may alternatively be a component of the processor. The processor and the storage medium may be located in an ASIC. In addition, the ASIC may be located in a base station or a terminal. Additionally, the processor and the storage medium may alternatively exist in a base station or a terminal as discrete components.

All or some of the foregoing embodiments may be implemented through software, hardware, firmware, or any combination thereof. When software is used for implementing the foregoing embodiments, all or a part of the foregoing embodiments may be implemented in a form of a computer program product. The computer program product includes one or more computer programs or instructions. When the computer programs or the instructions are loaded and executed on a computer, the procedures or functions in embodiments are all or partially executed. The computer may be a general-purpose computer, a dedicated computer, a computer network, a network device, user equipment, or another programmable apparatus. The computer program or the instructions may be stored in a non-transitory computer-readable storage medium, or may be transmitted from a non-transitory computer-readable storage medium to another non-transitory computer-readable storage medium. For example, the computer program or the instructions may be transmitted from a website, computer, server, or data center to another website, computer, server, or data center in a wired or wireless manner. The non-transitory computer-readable storage medium may be any usable medium that can be accessed by the computer, or a data storage device such as a server or a data center integrating one or more usable media. The usable medium may be a magnetic medium, for example, a floppy disk, a hard disk, or a magnetic tape; or may be an optical medium, for example, a digital video disc; or may be a semiconductor medium, for example, a solid-state drive. The non-transitory computer-readable storage medium may be a volatile or non-volatile storage medium, or may include two types of storage media: a volatile storage medium and a non-volatile storage medium.

In various embodiments, unless otherwise stated or there is a logic conflict, terms and/or descriptions in different embodiments are consistent and may be mutually referenced, and features in different embodiments may be combined based on an internal logical relationship thereof, to form a new embodiment.

In the embodiments, “at least one” means one or more, and “a plurality of” means two or more. The term “and/or” describes an association relationship between associated objects and represents that three relationships may exist. For example, A and/or B may represent the following cases: only A exists, both A and B exist, and only B exists. A and B may be singular or plural. In the descriptions of the embodiments, the character “/” indicates an “or” relationship between the associated objects. In a formula in the embodiments, the character “/” indicates a “division” relationship between the associated objects. “Including at least one of A, B, and C” 10 may represent: including A; including B; including C; including A and B; including A and C; including B and C; and including A, B, and C.

1. An apparatus comprising:
an interface circuit configured to receive collected information from a detector, wherein the collected information comprises at least one of: reflected-light information of a user, thermal radiation information of the user, and image information of the user; and
a processing circuit configured to:
determine, based on the collected information, a first optical receiver unit that is in the detector and that collects region of interest (ROI) information of the user;
determine, based on a correspondence between optical receiver units and time units, a first time unit corresponding to the first optical receiver unit; and
increase an irradiation power of a light source in the first time unit.

2. The apparatus according to claim 1, wherein the processing circuit is further configured to control a communication apparatus to increase the irradiation power of the light source in the first time unit.

3. The apparatus according to claim 2, wherein the interface circuit is further configured to send notification information to the communication apparatus, and the notification information is used to notify the communication apparatus to increase the irradiation power of the light source in the first time unit.

4. The apparatus according to claim 1, wherein the processing circuit is further configured to:
determine at least one of the following information of the user based on the collected information: depth information, light intensity information, or temperature information, wherein the depth information comprises information about a distance between the user and the detector; and
determine, based on at least one of the depth information, the light intensity information, or the temperature information of the user, the first optical receiver unit that is in the detector and that collects the ROI information of the user.

5. The apparatus according to claim 1, wherein the processing circuit is further configured to determine a communication time unit based on the first time unit, wherein no intersection set exists between the communication time unit and the first time unit; and
the interface circuit is further configured to send a communication signal to the communication apparatus in the communication time unit.

6. The apparatus according to claim 1, wherein the first time unit is a time unit in one or more periodicities, and each periodicity is determined based on exposure time of optical receiver units comprised in an optical receiving array in the detector.

7. The apparatus according to claim 1, wherein the processing circuit is further configured to adjust the first time unit corresponding to the first optical receiver unit; and
the interface circuit is further configured to send notification information to the detector, the light source, and the communication apparatus, wherein the notification information is used to notify to adjust the first time unit corresponding to the first optical receiver unit.

8. The apparatus according to claim 7, wherein the processing circuit is further configured to update the correspondence between optical receiver units and time units based on an adjusted first time unit corresponding to the first optical receiver unit.

9. An apparatus comprising:
an interface circuit configured to receive notification information from a processing apparatus, wherein the notification information is used to notify a communication apparatus to increase an irradiation power of a light source in a first region of interest (ROI) time unit; and
a processing circuit is configured to control the light source to increase the irradiation power in a first time unit.

10. The apparatus according to claim 9, wherein the first time unit is a time unit in one or more periodicities, and each periodicity is determined based on exposure time of optical receiver units comprised in an optical receiving array in a detector.

11. The apparatus according to claim 10, wherein the first time unit is an ROI time unit in one periodicity, and the processing circuit is further configured to:
modulate a control signal in the first time unit, to determine a first modulated signal; and
control, based on the first modulated signal, the light source to increase the irradiation power.

12. The apparatus according to claim 10, wherein the first time unit is ROI time units in a plurality of periodicities, and the processing circuit is further configured to:
determine, based on the first time unit, a second ROI time unit corresponding to each periodicity of the plurality of periodicities;
modulate a control signal in the second ROI time unit in each periodicity, to determine a second modulated signal; and
control, based on the second modulated signal, the light source to increase the irradiation power.

13. The apparatus according to claim 9, wherein the interface circuit is further configured to receive a communication signal from the processing apparatus in a communication time unit, wherein no intersection set exists between the communication time unit and the first time unit; and the processing circuit is further configured to:
modulate the communication signal in the communication time unit, to determine a third modulated signal; and
control, based on the third modulated signal, the light source to increase the irradiation power.

14. The apparatus according to claim 9, wherein the interface circuit is further configured to receive notification information from the processing apparatus, wherein the notification information is used to notify to adjust a first ROI time unit corresponding to a first optical receiver unit; and
the processing circuit is further configured to adjust, based on the notification information, the first ROI time unit corresponding to the first optical receiver unit.

15. A system comprising:
a processing apparatus, configured to:
determine, based on collected information about a user, a first optical receiver unit in a detector that collects region of interest (ROI) information of the user, and
determine, based on a correspondence between optical receiver units and time units, a first time unit corresponding to the first optical receiver unit; and
a communication apparatus, configured to control a light source to increase an irradiation power in the first time unit.

16. The system according to claim 15, further comprising:
a detector, configured to collect the information about the user, to determine the collected information, wherein the collected information comprises at least one of the following: reflected-light information of the user, thermal radiation information of the user, and image information of the user.

17. The system according to claim 16, wherein the detector comprises an optical receiver, the optical receiver comprises at least one optical receiving array, the optical receiving array comprises a plurality of optical receiver units, and one periodicity is determined based on exposure time of the optical receiver units comprised in the optical receiving array.

18. The system according to claim 15, wherein, when determining, based on the collected information about the user, the first time unit in the detector that collects the ROI information of the user, the processing apparatus is further configured to:
determine at least one of the following information of the user based on the collected information: depth information, light intensity information, or temperature information, wherein the depth information comprises information about a distance between the user and the detector; and
determine, based on at least one of the depth information, the light intensity information, or the temperature information of the user, the first optical receiver unit in the detector that collects the ROI information of the user.

19. The system according to claim 15, wherein, when the first time unit is an ROI time unit in one periodicity, the processing apparatus is further configured to:
modulate a control signal in the first time unit, to determine a first modulated signal; and
control based on the first modulated signal, the light source to increase the irradiation power.

20. The system according to claim 15, wherein, when there are ROI time units in a plurality of periodicities, the processing apparatus is further configured to:
determine, based on the first time unit, a second ROI time unit corresponding to each periodicity of the plurality of periodicities;
modulate a control signal in the second ROI time unit in each periodicity, to determine a second modulated signal; and
control, based on the second modulated signal, the light source to increase the irradiation power.
